(19) United States
(12) Patent Application Publication
(10) Pub. No.: US 2007/0241152 A1
(43) Pub. Date: Oct. 18, 2007

(54) Beverage cooler / heater

(76) Inventor: Robert L Josephs, Palm Bay, FL (US)

Correspondence Address: ROBERT L JOSEPHS, 370 LAKE VIEW LA, PALM BAY, FL, 32909-7123, US

(21) Appl. No.: 11/404,992

(22) Filed: Apr. 17, 2006

(51) Int. Cl. B60R 7/06; B60R 11/00

(52) U.S. Cl. 224/483; 224/544; 224/556; 224/926

(57) ABSTRACT

Driver and or passenger in a motor vehicle often have need to cool or warm, or to otherwise maintain the temperature of the contents of a container, typically cans or bottles. Option “A” In the cooling mode a substance may be a carbonated beverage, juice, water or other beverage. Option “B” In the cooling mode refrigeration can be applied to cans or bottles of carbonated beverage, juice, water or other beverage. In the heating mode heat may be applied to coffee, tea, milk or baby formula, or other contained liquid. Because of it's semi enclosed form the hemi cylindrical container can also be utilized for small plastic boxes, bags or sacks. This is significant because these forms of packaging have become quite prevalent in recent years. A secure coupling is provided for connecting the hemi cylindrical housing to virtually any air duct in any motor vehicle.

### BACKGROUND OF THE INVENTION

It is frequently necessary or convenient to cool or heat a beverage while in a motor vehicle. The cooling or maintaining of a cool temperature of the contents of a can, bottle or other container is accomplished by utilizing the flow of cold air emitted from a vehicle's air conditioning duct. In a like manner a container of liquid can be heated by directing heated air to the air vent. The cooling mode will be utilized for carbonated beverages, water, juices, or other liquids. Similarly, hot or warm containers of coffee, tea, baby formula or other drinks can be raised and maintained at a desirable temperature. When in the heating mode a baby's bottle can be warmed to a desired temperature.

The patent to Kutzner, U.S. Pat. No. 20020179282, is of interest to the overall subject matter. His design is inefficient and the mounting is unstable.

### SUMMARY OF THE INVENTION

It is an objective of this invention to safely and securely connect a semi enclosed container to an air duct in a motor vehicle.

It is a further objective of this invention to provide a safe, tip proof, rigidly coupled, easily attached and detached connection of a semi enclosed container, thereby facilitating easy installation and removal from one vehicle to another, or one air duct to another.

It is another objective of this invention to utilize the motor vehicle's cooling system to provide cold air to cool a container of liquid. The temperature of the cooled air emitted from a vent duct is typically 42° Fahrenheit.

It is another objective of this invention to utilize the motor vehicle's heating system to provide hot air to heat a container of liquid. The temperature of the heated air emitted from a vent duct is typically 140° Fahrenheit.

It is another objective of this invention to contain and utilize the vehicle's cooled or heated air efficiently before returning it to the passenger compartment for the occupant's comfort.

### BRIEF DESCRIPTION OF THE DRAWINGS

FIG. 1 the front view showing the location of the rear mounting bar

FIG. 2 the top view of the hemi cylindrical container without the latching hooks.

FIG. 3 the top view of the hemi cylindrical container with the latching hooks. The latching hooks are shown in position for wide vents (A) and for narrow vents (B).

FIG. 4 the side view of the hemi cylindrical container, sans locking mechanism.

FIG. 5 the side view of the hemi cylindrical container with locking mechanism

FIG. 6 the oblique view of the hemi cylindrical container as it would attach to a vehicle's panel.

FIG. 7 detailed drawings of the latch mechanism in two views.

### DETAILED DESCRIPTION OF THE DRAWINGS

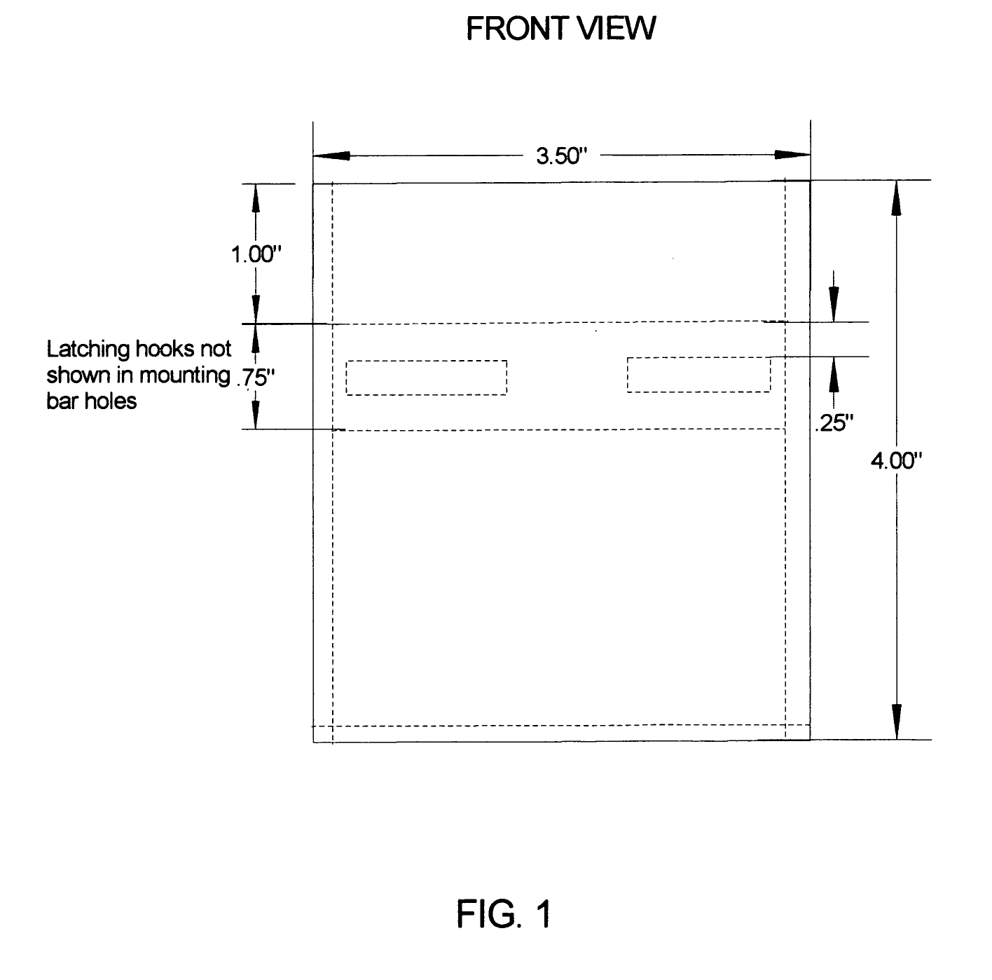

FIG. 1 the front view showing the location of the rear mounting bar. The rear mounting bar is permanently attached to the sides of the hemi cylindrical container. There are two elongated slots in the mounting bar to facilitate moving the latching hooks to a position that enables them to be hooked to the inside of the dash at the sides of the vent.

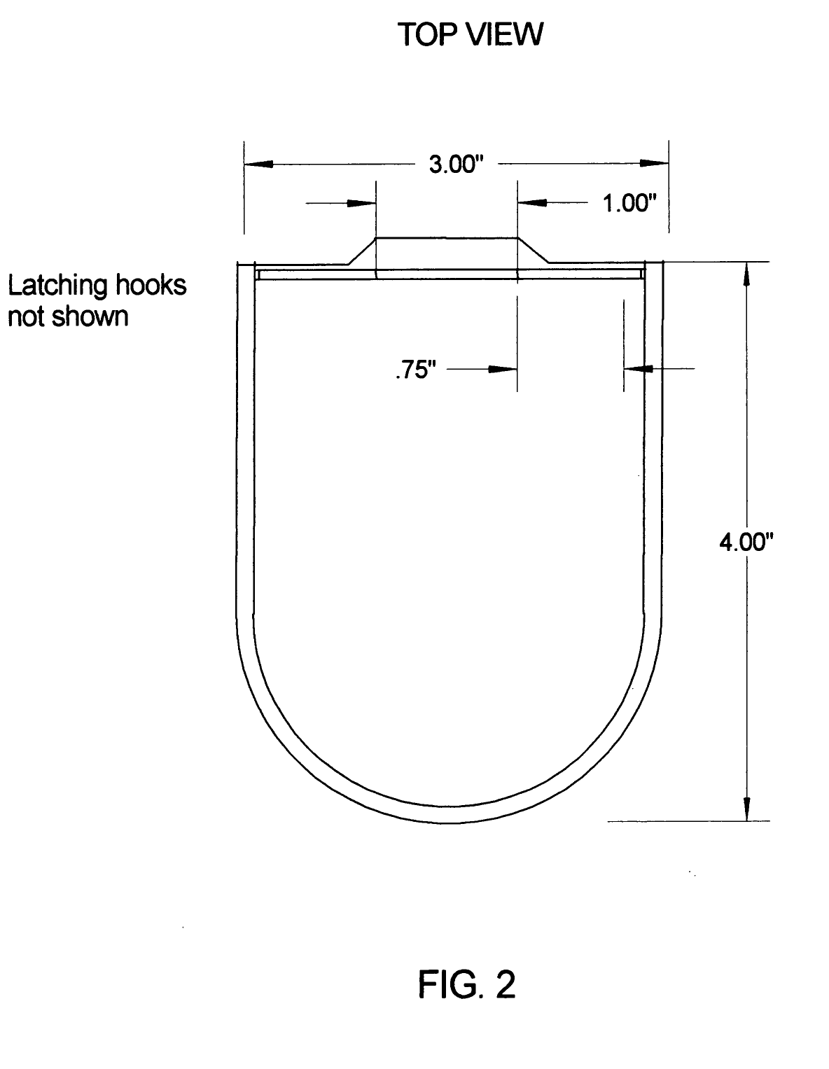

FIG. 2 the top view of the hemi cylindrical container. A lip is seen projection from the base plate.

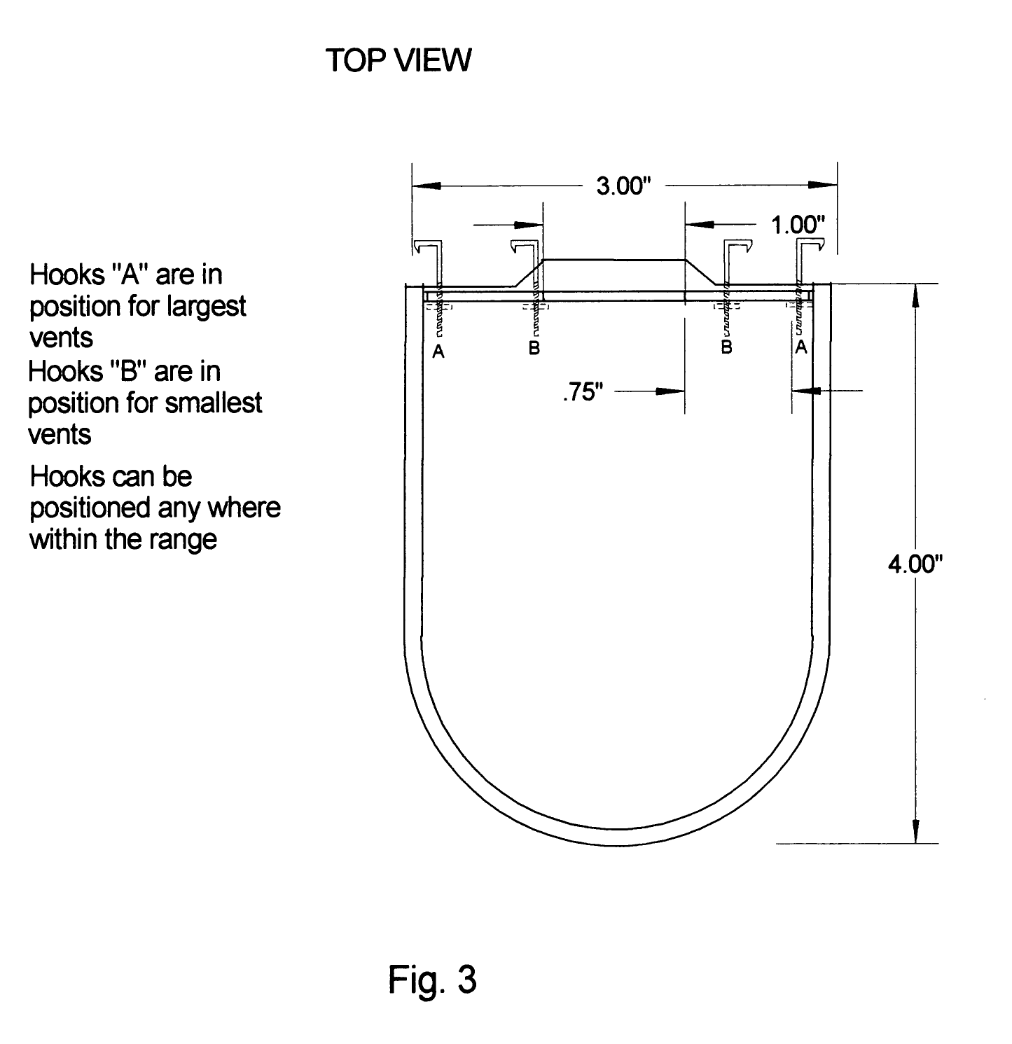

FIG. 3 the top view of the hemi cylindrical container with the latching hooks. The latching hooks are shown in two positions. Positions for wide vents (A) and for narrow vents (B). They may be positioned anywhere in the range as required.

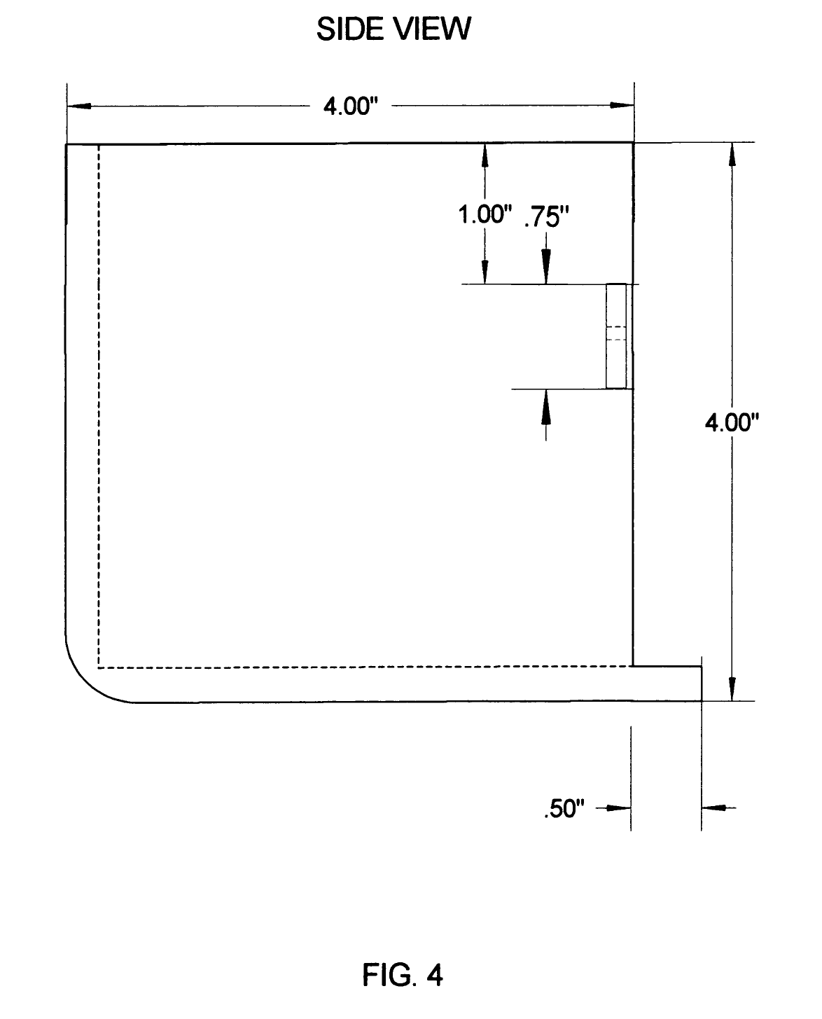

FIG. 4 the side view of the hemi cylindrical container with a lip on the bottom plate. The locking mechanism is omitted on this drawing.

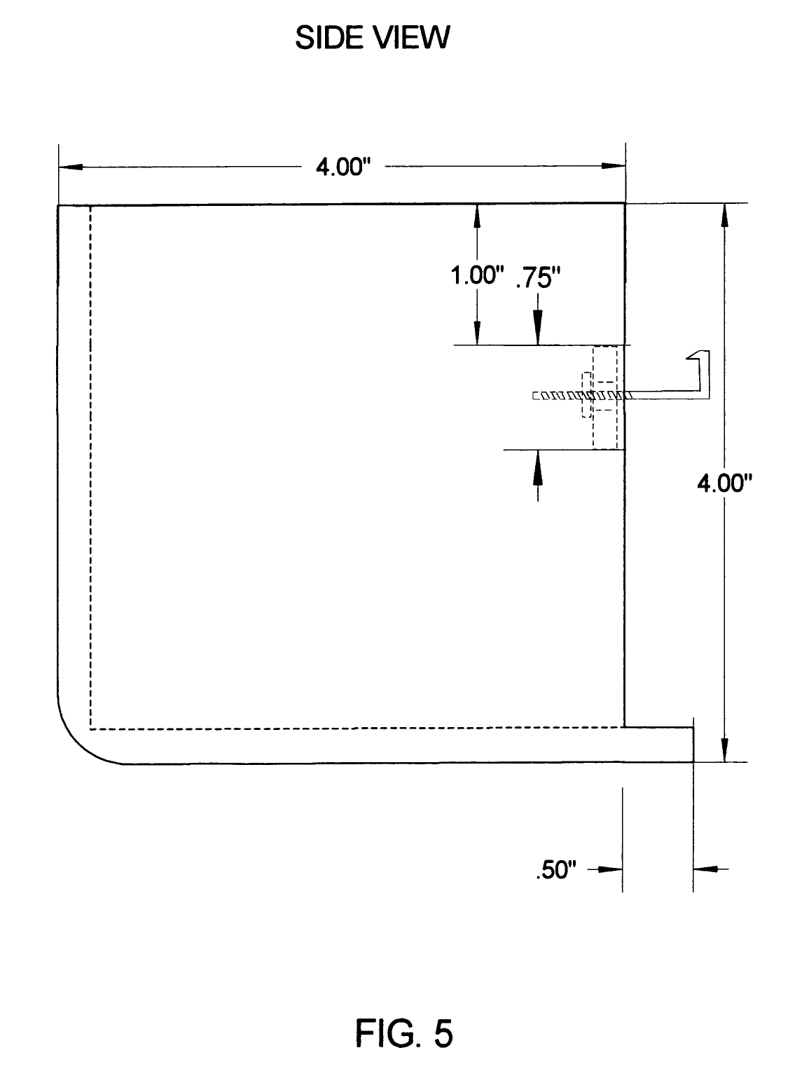

FIG. 5 the side view of the hemi cylindrical container with locking mechanism projecting through the mounting bar. The latching hook is shown rotated 90° into vertical for illustration purposes only.

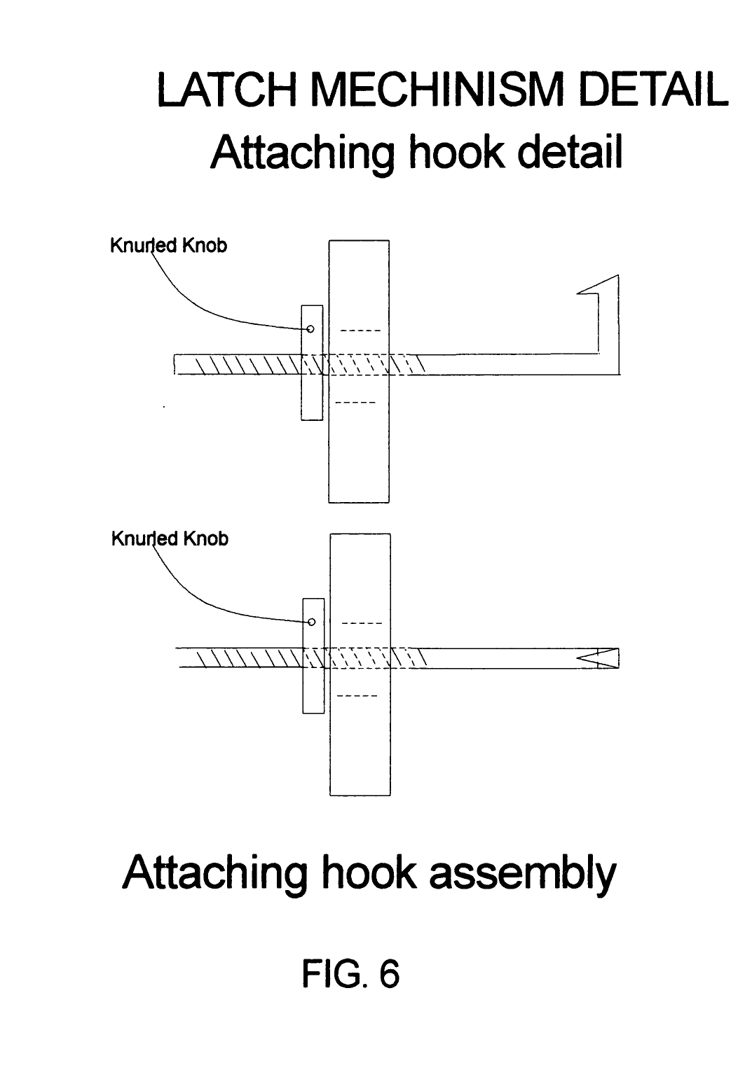

FIG. 6 the latch mechanism in two views. View “A” is for illustration only. View “B” is rotated into it's operating position. The knurled knob on the threaded shaft is used to draw the hemi cylindrical container tightly against the sides and bottom of the air vent. The latch mechanism will be provided in several lengths from 1 inch to 4 inches making the hemi cylindrical container fit virtually every vehicle.

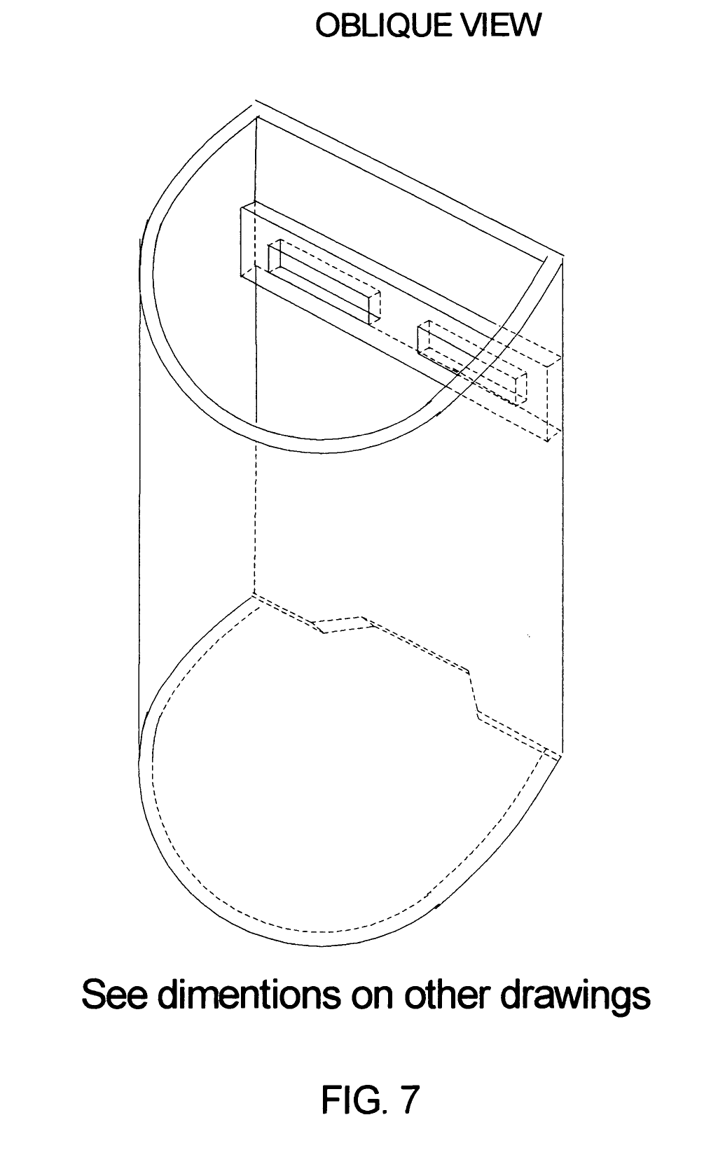

FIG. 7 the oblique view of the hemi cylindrical container is an overview, as it would attach to the air vent in virtually any vehicle's panel.

I claim:

1. A hemi cylindrical housing of semi rigid material of a size and shape to securely hold a container in close proximity to the air duct of a motor vehicle. The object of which is to impart cold or hot air to a container placed within the hemi cylindrical container.

2. The tempered air omitted from the duct is contained in the hemi cylindrical container which surrounds the beverage container and is then sent to the passenger compartment.

3. The mounting device will accommodate narrow and wide air vents.

4. The attachment hooks will securely connect the hemi cylindrical container to the air vent.

5. The invention will easily support a 16 ounce can or baby bottle filled with liquid.
